(19) United States
(12) Patent Application Publication
(10) Pub. No.: US 2020/0019397 A1
(43) Pub. Date: Jan. 16, 2020

(54) SYSTEM AND METHOD FOR CONTROLLING ROLLBACK OF FIRMWARE

(71) Applicant: Seagate Technology LLC, Cupertino, CA (US)

(72) Inventors: Anthony Ramon DURAN, Longmont, CO (US); Nino WICAKSONO, Singapore (SG); Asif Hameed KHAN, Singapore (SG)

(21) Appl. No.: 16/035,523

(22) Filed: Jul. 13, 2018

(51) Int. Cl. G06F 8/65; H04L 12/24; H04L 9/32; G06F 21/57

(52) U.S. Cl. CPC G06F 8/65; H04L 41/0863; G06F 21/572; H04L 41/0893; H04L 9/3247; H04L 41/082

(57) ABSTRACT

A method includes receiving a firmware package including at least one firmware element having a security revision number. The security revision number of the at least one firmware element is compared to at least one firmware state identifier to determine if the firmware package is a rollback. At least one rollback policy is applied to the firmware package to approve or reject the firmware package when the firmware package is a firmware rollback. The firmware package is installed when the firmware package is approved by the at least one rollback policy.

### SUMMARY

Provided herein is a method that includes receiving a firmware package including at least one firmware element having a security revision number. The security revision number of the at least one firmware element is compared to at least one firmware state identifier to determine if the firmware package is a rollback. At least one rollback policy is applied to the firmware package to approve or reject the firmware package when the firmware package is a firmware rollback. The firmware package is installed when the firmware package is approved by the at least one rollback policy.

These and other features and advantages will be apparent from a reading of the following detailed description.

### BRIEF DESCRIPTION OF DRAWINGS

FIG. 1 shows a firmware update system according to one aspect of the present embodiments.

FIG. 2 illustrates a secure boot device state according to one aspect of the present embodiments.

FIG. 3A shows a firmware package including a first version of a device firmware element and a first version of a component firmware element according to one aspect of the present embodiments.

FIG. 3B shows a firmware package including a second version of the device firmware element and a second version of the component firmware element according to one aspect of the present embodiments.

FIG. 3C shows a firmware package including a third version of a device firmware element and the second version of the component firmware element according to one aspect of the present embodiments.

FIG. 3D shows a partial firmware package including a third version of the component firmware element according to one aspect of the present embodiments.

FIG. 4 shows an illustrative method of downloading, verifying, and authorizing a firmware package according to one aspect of the present embodiments.

FIG. 5 shows an illustrative method of applying one or more policies to a firmware package according to one aspect of the present embodiments.

FIG. 6 shows an illustrative method of downloading, verifying, and authorizing a firmware package using at least one configurable port according to one aspect of the present embodiments.

FIG. 7 shows a standard firmware update according to one aspect of the present embodiments.

FIG. 8 shows an approved rollback firmware update according to one aspect of the present embodiments.

FIG. 9 shows a rejected rollback firmware update according to one aspect of the present embodiments.

### DESCRIPTION

Before various embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein.

It should also be understood that the terminology used herein is for the purpose of describing the certain concepts, and the terminology is not intended to be limiting. Unless defined otherwise, all technical and scientific terms used herein have the same meaning as commonly understood in the art to which the embodiments pertain.

Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that the singular forms of “a,” “an,” and “the” include plural references unless the context clearly dictates otherwise.

Some portions of the detailed descriptions that follow are presented in terms of procedures, methods, flows, logic blocks, processing, and other symbolic representations of operations performed on a computing device or a server. These descriptions and representations are the means used by those skilled in the data processing arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical or magnetic signals capable of being stored, transferred, combined, compared, and otherwise manipulated in a computer system or computing device or a processor. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “storing,” “determining,” “sending,” “receiving,” “generating,” “creating,” “fetching,” “transmitting,” “facilitating,” “providing,” “forming,” “detecting,” “decrypting,” “encrypting,” “processing,” “updating,” “instantiating,” “communicating,” “comparing,” “erasing,” “issuing,” “locking,” or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

It is appreciated that present systems and methods can be implemented in a variety of architectures and configurations. For example, present systems and methods can be implemented as part of a distributed computing environment, a cloud computing environment, a client server environment, hard drive, etc. Embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular data types. The functionality of the program modules may be combined or distributed as desired in various embodiments.

Computer storage media can include volatile and nonvolatile, removable and non-removable media implemented in any method or technology for storage of information such as computer-readable instructions, data structures, program modules, or other data. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can be accessed to retrieve that information.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

There has been a growing need for controlling installation of firmware package including one or more modifications to a firmware element maintained by a system. For example, a need has arisen to prevent installation of prior (e.g., older) firmware versions that include previously corrected security flaws or vulnerabilities. Preventing installation of prior firmware versions has become more important as distribution of vulnerabilities and exploits has increased, for example, over the internet.

Moreover, as the ability to mimic (or impersonate) a firmware distributor has increased, for example due to network or internet vulnerabilities, so has the need to ensure that firmware updates are provided by authorized providers and/or under authorized conditions. Thus, there is a need to verify that a firmware update (or version) is provided by an authorized provider and includes authorized elements.

It is appreciated that while embodiments are described with respect to a firmware update of a storage system, the embodiments are not limited thereto. For example, the embodiments are equally applicable to other electronic devices, e.g., solid state devices or non-storage devices, such as computer systems.

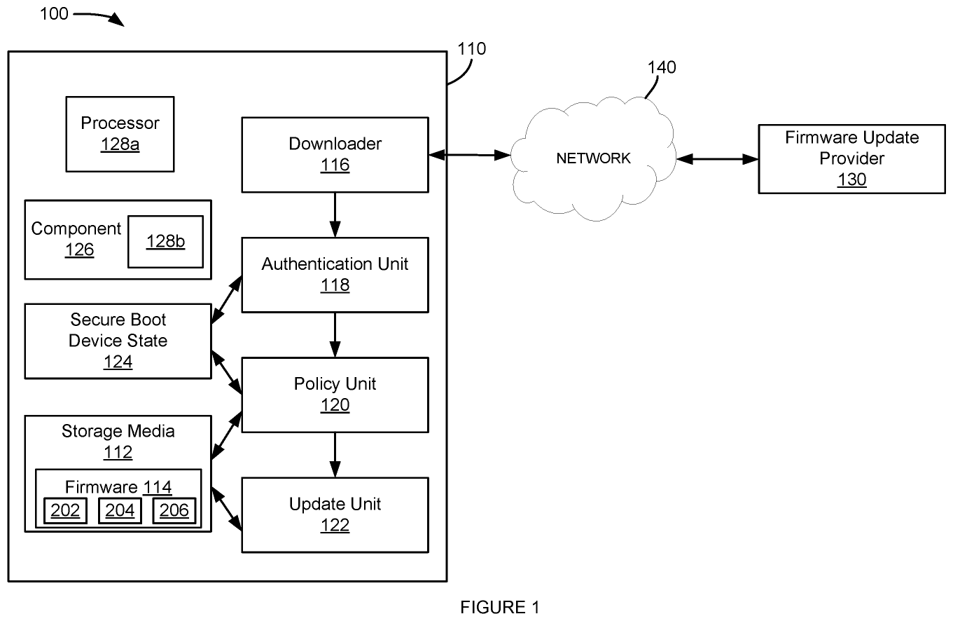

Referring now to FIG. 1, firmware downloading and updating according to one aspect of the present embodiments is shown. An environment 100 includes a system 110 having a storage media 112 including firmware 114. In some embodiments, firmware 114 includes one or more executable files, programs, and/or other software configured to provide low-level control for one or more hardware and/or software components of the system 110. Firmware 114 may provide a standardized operating environment for other software implemented by the system 110, act as an operating system for the system 110 (for example, providing control, monitoring, data manipulation, etc.), and/or any other suitable controls.

In the illustrated embodiment, the firmware 114 includes a device firmware element 202 configured to provide firmware for the system 110, a component firmware element 204 configured to provide firmware specific to a component 126 of the system 110, and a database identifier 206 configured to identify a database of verification data associated with one or more firmware providers 130. Although embodiments are discussed herein including a single component 126 and corresponding component firmware element 204, it will be appreciated that the system 110 can include any number of components having component specific firmware elements included in the firmware 114. Each of the firmware elements 202, 204 can be implemented by one or more processors included in the system 110. For example, in the illustrated embodiment, a system processor 128A is configured to load and execute the device firmware element 202 and a component processor 128B is configured to load and the component firmware element 204. Although embodiments are discussed herein including a system processor 128A and a component processor 128B, it will be appreciated that the system 110 and/or the component 126 can include any number of processors configured to load and execute elements of the firmware 114.

In various embodiments, it is advantageous for the firmware 114 to be updatable by the system 110. For example, firmware 114 may be updated to eliminate one or more existing vulnerabilities (e.g., bugs) in the firmware 114, enable and/or disable one or more additional or alternative functions of the system 110, improve performance of the system 110, and/or for any suitable reason. A firmware package (including one or more firmware changes and/or updates) may be provided by a firmware provider 130, such as, for example, an original equipment manufacturer (OEM) of the system 110, an OEM of one or more components 126 contained within the system 110, a party licensed by an OEM, a software vendor, and/or any other suitable provider. The firmware provider 130 provides one or more firmware packages to the system 110 via a suitable communication link. For example, in various embodiments, the firmware provider 130 may provide a firmware update via a network 140 (such as a local area network, wide-area network, the Internet, etc.), a direct input to the system 110 (such as a removable storage media coupled to one or more ports on the system 110), and/or any other suitable data transfer mechanism.

The system 110 is configured to verify a firmware package prior to installing the firmware package. In the illustrated embodiment, the system 110 includes a downloader 116 configured to receive a firmware package from the firmware provider 130. The downloader 116 stores the firmware package in storage media without updating the firmware contained on the storage device 112. The storage media may be the storage media 112 and/or a separate storage media.

In some embodiments, an authentication unit 118 is configured to verify the firmware package. The authentication unit 118 compares one or more elements of the firmware package to one or more known identifiers associated with the firmware provider 130 to determine if the firmware update originated with the firmware provider 130. For example, and as discussed in greater detail below, the firmware authentication unit 118 may compare a cryptographically generated private signature with a public key associated with the firmware provider 130 to determine authenticity of the firmware package. Although embodiments are discussed herein including public-private key signatures, it will be appreciated that any suitable secure verification system may be used to verify the origin of the firmware package by the firmware authentication unit 118. For example, in various embodiments, the authentication unit 118 may use a cryptographic signature, a distributed ledger entry, a digital certificate, an offline verification, and/or any other suitable verification scheme.

In some embodiments, a policy unit 120 is configured to store one or more policies for approving and/or implementing authenticated firmware packages. For example, and as discussed in greater detail below, the policy unit 120 can include one or more rollback policies configured to approve or reject a firmware rollback. In various embodiments, the policy engine 120 may implement policies based on any suitable elements of the firmware package, such as version numbers of firmware elements, secure database identifiers, digital signatures, and/or any other suitable identifiers included in the firmware package.

In some embodiments, an update unit 122 is configured to replace one or more firmware elements 202, 204 of the firmware 114 with corresponding elements contained in a verified and approved firmware package. The update unit 122 may be configured to directly update the firmware 114 stored on the storage media 112 and/or may be configured to call an update routine implemented by one or more processors 128A, 128B, for example, an update routine stored within the firmware 114 on the storage media 112.

In some embodiments, a secure boot device state 124 is maintained by the system 110. The secure boot device state 124 includes one or more state identifiers associated with the system 110. The state identifiers are associated with at least one aspect of a firmware element 202-206, such as a version number, an identifier number, etc. The secure boot device 124 may be maintained on the storage media 112, on a separate storage media, and/or may be hardcoded into a portion of the system 110. The state indicators maintained by the secure boot device state 124 are used by the authentication unit 118 (e.g., to verify a downloaded firmware package), the policy unit 120 (e.g., to enforce a firmware rollback policy), and/or any other element of the system 110 to verify and approve a firmware package. In some embodiments, the state indicators maintained by the secure boot device state 124 may be updated only by specific elements and/or under specific conditions, such as by the firmware update unit 122 during an approved firmware update and/or by a predetermined update mechanism. In some embodiments, one or more state indicators may be fixed and/or unchangeable. For example, in some embodiments, a signed authority database 206 may be established when the system 110 is manufactured and may not be changeable.

Although the downloader 116, the authentication unit 118, the policy unit 120, and the update unit 122 are illustrated as an independent elements, it will be appreciated that any of the downloader 116, the authentication unit 118, the policy unit 120, and the update unit 122 can be formed integrally with and/or otherwise included in one or more other elements. For example, in some embodiments, the policy unit 120 is maintained by and/or combined with the secure boot device state 124.

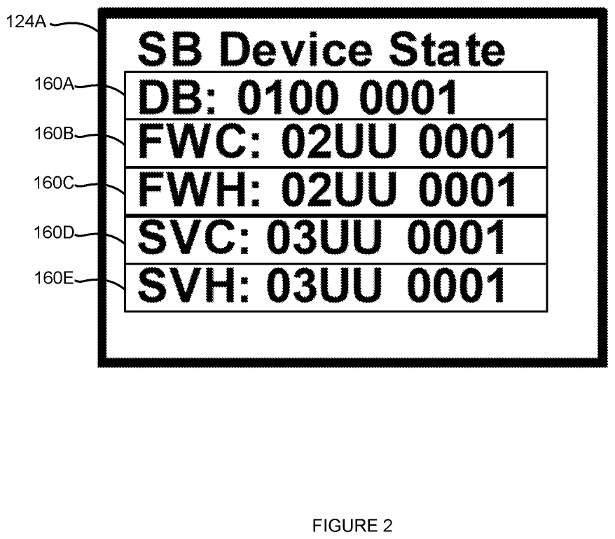

Referring now to FIG. 2, an exemplary secure boot device state 124A according to one aspect of the present embodiments is disclosed. The secure boot device state 124A includes a plurality of state identifiers 160A-160E (collectively “state identifiers 160”). Each of the state identifiers 160 maintain state information corresponding to one or more elements of the firmware 114 and/or the system 110. For example, in various embodiments, the state identifiers 160 can include, but are not limited to, a secure database identifier 160A associated with a secure database containing verification data for use in verifying downloaded firmware packages, a current device firmware version identifier 160B configured to identify the current version of the device firmware element 202 in the firmware 114, a highest device firmware version identifier 160C configured to identify the highest version of the device firmware element 202 that has ever been installed on the system 110, a current component firmware version identifier 160D configured to identify a current version of the component firmware element 204 in the firmware 114, a highest component firmware version identifier 160E configured to identify the highest version of the component firmware element 204 that has ever been installed on the system 110, and/or any other suitable identifier. Although embodiments are discussed herein including a set of device firmware identifiers 160B-160C and a single set component firmware identifiers 160D-160E, it will be appreciated that the secure boot device state 124A can include any suitable number of identifiers associated with any suitable number of components and/or portions of the system 110.

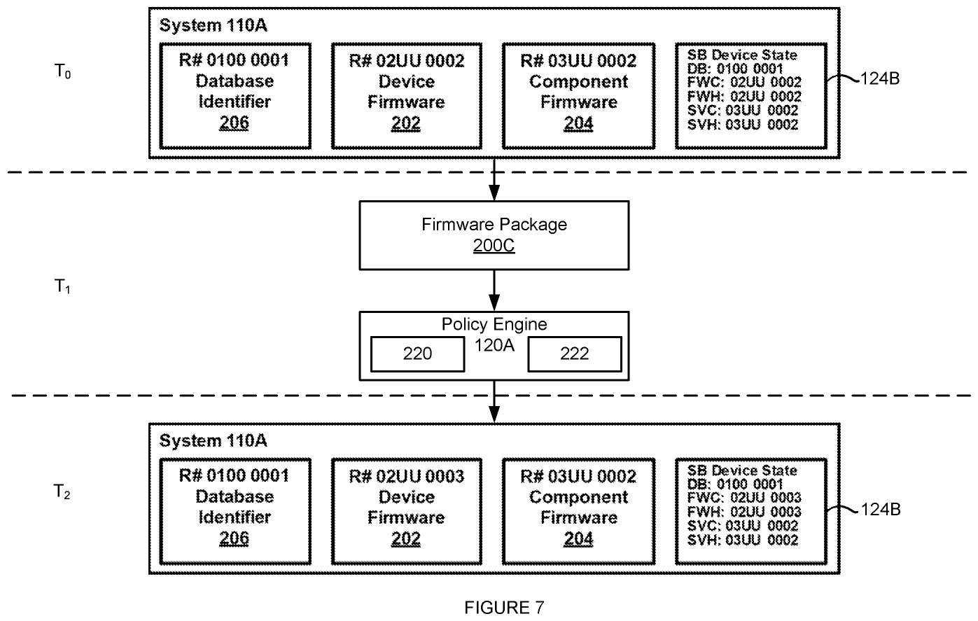

In some embodiments, each of the state identifiers 160 include a security revision number for the associated data element (e.g., secure database identifier 206, device firmware element 202, component firmware element 204, etc.). Security revision numbers begin at a predetermined vale (e.g., 0000, 0001, etc.) and are incremented by a predetermined increment (e.g., incrementing by 1) for each new iteration of the associated data element that is generated by an authorized provider, such as firmware provider 130. For example, in some embodiments, a system 110 can include a first security revision (e.g., 0001) of the device firmware element 202 and a first security revision (e.g., 0001) of the component firmware element 204 when the system 110 is manufactured. The secure boot device state 124A includes a current device firmware identifier 160B having a value of 0001 (the security revision number of the first version of the device firmware element 202) and a current component firmware identifier 160D having a value of 0001 (the security revision number of the component firmware element 204). If a new version of the device firmware element 202 is provided by the firmware provider 130, the new version will include an incremented security revision number (e.g., 0002) and the current device firmware identifier 160B will be updated with the new security revision number when the device firmware element 202 is updated to version 0002. In some embodiments, the highest device firmware version identifier 160C may also be updated, as discussed in greater detail below with respect to FIGS. 7-9.

In some embodiments, a security revision number may include a unique identifier for each specific firmware element 202-206. As shown in the illustrated embodiment, a portion of each of the identifiers 160A-160E identify the corresponding firmware element 202-206 associated with the identifier 160A-160E. For example, the current device firmware version identifier 160B and the highest device firmware version identifier 160C each include a four digit code identifying the device firmware element (e.g., 02TT). Similarly, the current component firmware version identifier 160D and the highest component firmware version identifier 160E each include a four digit code identifying the component firmware element (e.g., 03TT). Although representative security revision numbering schemes are discussed herein, it will be appreciated that the firmware elements can use any sequential identification scheme (e.g., numbering, lettering, etc.) to identify versions of the various elements 202-206.

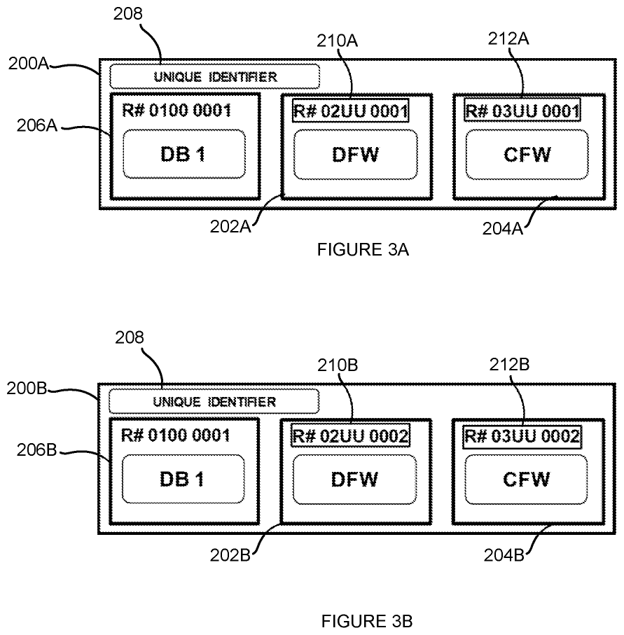

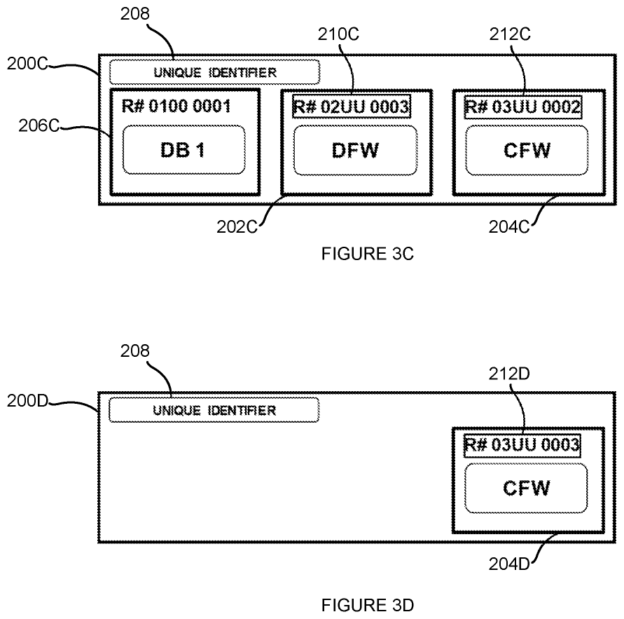

Referring now to FIGS. 3A-3C, exemplary firmware packages 200A-200C (collectively “firmware packages 200”) according to one aspect of the present embodiments are disclosed. The firmware packages 200 are representative of a firmware package that may be downloaded by the system 110 from the firmware provider 130. Each firmware package 200A-200C includes a plurality of firmware elements 202A-202C, 204A-204C (collectively “firmware elements 202A-204C”). The firmware elements 202A-204C each include one or more software packages and/or code segments configured to replace and/or update existing firmware elements 202, 204 stored on the system 110. In some embodiments, the firmware packages can include, but are not limited to, device firmware elements 202A-202C and/or component specific firmware elements 204A-204C. Although embodiments are illustrated including a single component firmware element 204A-204C, it will be appreciated that each of the firmware packages 200 can include any suitable number of component firmware elements 204A-204C corresponding to any number of components 126 in the system 110.

In some embodiments, each of the firmware elements 202A-204C includes a security revision number 210A-210C, 212A-212D (collectively “security revision numbers 210-212”) associated therewith. The security revision numbers 210-212 each identify the current iteration of the associated firmware elements 202A-204C contained in the firmware package 200. As discussed above, in some embodiments, the security revision numbers 210-212 can include an element identifier (e.g., 02TT, 03TT, 0100, etc.) and a version identifier (e.g., 0001, 0002, 0003, etc.). The version number identifiers begin at a predetermined vale (e.g., 0000, 0001, etc.) and are incremented by a predetermined increment (e.g., incrementing by 1) for each new iteration of the firmware element 202A-204C that is published. As discussed in greater detail below, the security revision numbers 210-212 are used by the system 110 to verify, approve, and track firmware and/or other software updates and changes.

In some embodiments, each of the firmware packages 200 includes a secure database identifier 206A-206C. The secure database identifiers 206A-206C identify a secure database of verification data associated with the firmware provider 130 (for example, public keys corresponding to private keys used by the firmware provider 130 to sign the firmware packages 200). The secure database identifiers 206A-206C contained in the firmware packages 200 may be used for verification and/or updating purposes. For example, in some embodiments, the system 110 is configured to compare a secure database identifier 160A stored in the secure boot device state 124 to a secure database identifier 206A-206C included in the firmware package 200. If the secure database identifiers 206, 206A-206C are the same, the firmware package 200 is provided to the authentication unit 118 to verify a digital signature of the firmware package 200. As another example, in some embodiments, the secure database identifiers 206A-206C included in a firmware package 200 can be used to update the secure database 206 of the firmware 114. For example, the secure database 206 can be updated in a similar fashion to the process for updating firmware elements 202, 204 described herein.

In some embodiments, each of the firmware packages 200 include a unique identifier 208. The unique identifier is configured to provide verification that the firmware package 200 was generated by a firmware provider 130. For example, in some embodiments, the unique identifier 208 is a digital signature generated by the firmware provider 130 and included in the firmware package 200. The digital signature can be generated using any suitable method, such as a public-private key cryptographic method. In other embodiments, the unique identifier 208 can include a digital certificate or other unique identification element that can be used by the system 110 to verify a source of the firmware package 200.

Referring now to FIG. 3D, a partial firmware package 200D according to one aspect of the present embodiments is disclosed. The partial firmware package 200D is similar to the firmware packages 200 discussed above, but only contains a component firmware element 204D. The partial firmware package 200D is treated similarly to the firmware packages 200 but only requires verification for the elements included in the partial firmware package 200D. For example, in various embodiments, the policy engine 120 is configured to only apply (i.e., check) policies corresponding to the firmware elements 204D contained in a partial firmware package 200D. If the policy engine 120 includes policies related to firmware elements not included in the partial firmware package 200D, those policies are ignored.

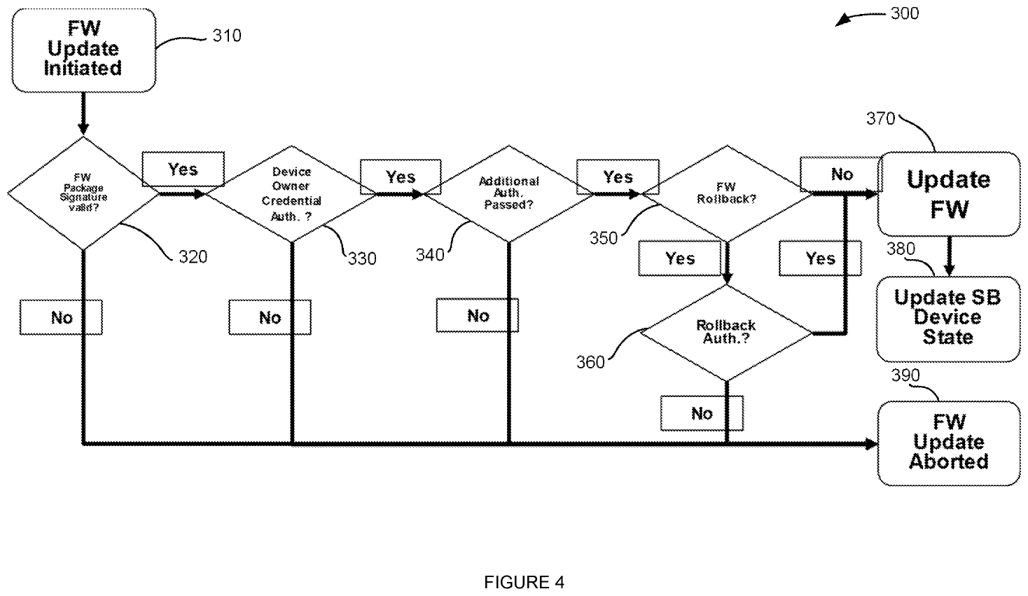

Referring now to FIG. 4, a method 300 of downloading, verifying, and approving a firmware package according to one aspect of the present embodiments is disclosed. At step 310, a firmware package, such as one of the firmware packages 200A-200D discussed above, is downloaded from a firmware provider 130. The system 110 may include a firmware downloader 116 configured to initiate a firmware download process and/or store a downloaded firmware package 200 in a storage media. The firmware package 200 may be provided in response to a request from the system 110 to the firmware provider 130 and/or may be provided by the firmware provider 130 without prompting (i.e., pushed to system 110). In some embodiments, the firmware package 200 is maintained in a storage media that is separate from the storage media 112 including the current firmware 114.

At step 320, the firmware package 200 is reviewed to verify that the firmware package 200 was received from an authorized firmware provider, such as firmware provider 130. In some embodiments, a unique identifier 208 included with the firmware package 200 is reviewed to determine the validity of the firmware package 200. For example, the firmware package 200 can include a unique identifier 208 including a digital signature generated by the firmware provider 130 using a suitable cryptographic signature method, such as a public-private key method. The digital signature is generated by the firmware provider 130 using a private key known only to the firmware provider 130. After receiving the firmware package 200, the authentication unit 118 compares the digital signature of the firmware package 200 to an authentication value generated using a public key corresponding to the private key. In some embodiments, the system 110 stores a copy of the public key and the authentication unit 118 generates the authentication value using the public key. In other embodiments, the authentication value is pregenerated using the public key and stored by the system 110, for example, in the secure database 206. The authorization value can include any suitable value, such as, for example, a hash value. If the unique identifier 208 is verified, the method 300 proceeds to step 330. If the digital signature is not verified, the method 300 proceeds to step 390 and the firmware package 200 is discarded without updating the firmware 114 on the system 110.

At step 330, the system 110 verifies that changes to the firmware 114 are authorized. For example, in some embodiments, a system 110 may be locked to prevent any updates to the firmware 114. The policy unit 120 may be configured to review a policy value configured to identify whether firmware updates are approved for the system 110. For example, in some embodiments, if a firmware update policy value has a first value (such as a TRUE value), the policy unit 120 authorizes the update and the method 300 proceeds to step 340. If the firmware update policy value has a second value (such as a FALSE value), the policy unit 120 indicates that firmware updates are not authorized and the method 300 proceeds to step 390. Although embodiments are discussed herein including authorization by the policy unit it will be appreciated that any suitable portion of the system 110 can be configured to authorize firmware changes and/or updates.

At step 340, the system 110 performs one or more additional authorization checks. For example, in some embodiments, the system 110 may require additional authorizations, such as requiring administrator or other authorization, approval of other devices and/or users that interact with the system 110, additional checks regarding the source and/or applicability of the firmware package 200, and/or any suitable authorization checks. If each of the additional authorization checks is passed (i.e., each authorization check indicates that a firmware update/the firmware package 200 is authorized), the method 300 proceeds to step 350. If any of the additional authorization checks fails, the method 300 proceeds to step 390.

At step 350, the firmware package 200 is compared to the firmware 114 stored on the system 110 to determine if the firmware package 200 is a firmware rollback. As used herein, the term rollback denotes a firmware package 200 that includes at least one firmware element 202A-204D having a lower security revision number (e.g., earlier version) as compared to corresponding firmware element 202-204 of the firmware 114 currently installed on the system 110. For example, in one embodiment, a system 110 may have a second version of the device firmware element 202 installed thereon. If the system 110 downloads a firmware package 200 containing a first version of a device firmware element 202, the firmware package 200 includes a rollback. Similarly, as another example, a system 110 may have a second version of the device firmware element 202 and a second version of the component firmware element Firmware 202 installed thereon. If the system 110 downloads a firmware package 200 containing a third version of the device firmware element 202 and first version of the component firmware element 204, the firmware package 200 includes a rollback due to the prior version of the component firmware element 204 included in the firmware package 200, despite the later version of the device firmware element 202 included in the firmware package 200. In some embodiments, the state identifiers 160A-160E maintained by the secure boot device state 124 are used to determine whether a firmware package 200 is a firmware rollback.

In some embodiments, a security revision number of each firmware element 202A-204C contained in the firmware package 200 is compared to the state identifier 160A-160E for the corresponding firmware element 202-206 maintained by the secure boot device state 124. If any one of the firmware elements 202A-204C contained in the firmware package 200 has a lower security revision number as compared to the corresponding state identifier 160A-160E, the firmware package 200 is identified as a firmware rollback, and the method 300 proceeds to step 360. If all of the firmware elements 202A-204C contained in the firmware package 200 have an equal or higher security revision number as compared to the corresponding state identifier 160A-160E, the firmware package 200 is identified as a standard firmware update, and the method 300 proceeds to step 370.

At step 360, the system 110 determines if the firmware rollback is an authorized firmware rollback. In some embodiments, a policy engine 120 maintains a firmware rollback policy limiting a rollback to firmware security revisions that are within a predetermined number of versions (or revisions) of current and/or prior versions of firmware elements 202, 204 installed on the system 110. For example, in some embodiments, the policy engine 120 maintains a firmware rollback policy allowing a rollback of a firmware element 202, 204 to versions having a security revision number equal to the current version of firmware element minus one (i.e., only allowing rollback to the most recent prior version of firmware). As another example, in some embodiments, the policy engine 120 maintains a firmware rollback policy allowing rollback to any version of a firmware element 202, 204 that has a security revision number equal to the current version of the firmware element 202, 204 minus three (e.g., current security revision number is 0004 and rollback policy allows up to the current security revision number minus 3 so any firmware element having a security revision number of 0001, 0002, or 0003 would be an approved firmware rollback).

In some embodiments, the policy engine 120 includes element-specific policies for each firmware element 202, 204 in the firmware 114. For example, if the firmware 114 includes a device firmware element 202 and a component firmware element 204, the policy engine 120 can maintain a device firmware policy for the device firmware element 202 and a component firmware policy for the component firmware element 204. For example, the policy engine 120 may maintain a device firmware policy allowing rollback of the device firmware element 202 to the current version minus one and a component firmware policy allowing rollback of the component firmware element 204 to the current version minus three. When the policy engine 120 receives a firmware package 200 for approval, the policy engine applies the specific policies for each firmware element 202, 204 included in the firmware package 200. For example, if a firmware package 200A includes a device firmware element 202A and a component firmware element 204A, the policy engine 120 applies both a device firmware policy and a component firmware policy. However, if the firmware package 200D includes only a component firmware element 204D, the policy engine 120 applies the component firmware policy and ignores the device firmware policy.

In some embodiments, the policy engine 120 includes one or more policies based on a highest firmware version identifier 160C, 160E maintained in the secure boot device state 124. The highest firmware version identifier 160C, 160E is updated each time a firmware element 202, 204 is updated to a higher security version number. For example, when the system 110 is initially manufactured, the system 110 may include a first version (0001) of the device firmware element 202. At the time of manufacture, t₀, both the current device firmware version identifier 160B and the highest device firmware identifier 160C are equal to 0001. At a first time, t₁, the system 110 is updated to a second version (0002) of the device firmware element 202 and both the current device firmware identifier 160B and the highest device firmware identifier 160C are updated to 0002. At second time, t₂, the system 110 receives a firmware package that includes a rollback of the device firmware element 202 to version 0001. After updating the firmware 114, the current firmware version identifier 160B reverts to 0001, indicating version 0001 is currently installed. However, the highest device firmware identifier 160D maintains a value of 0002, indicating that the highest security revision (e.g., version) of the device firmware element 202 that has been on the device is 0002. Policies based on the highest firmware version identifiers 160C, 160E can prevent sequential rollback of firmware beyond those rollbacks approved by the policy engine 120.

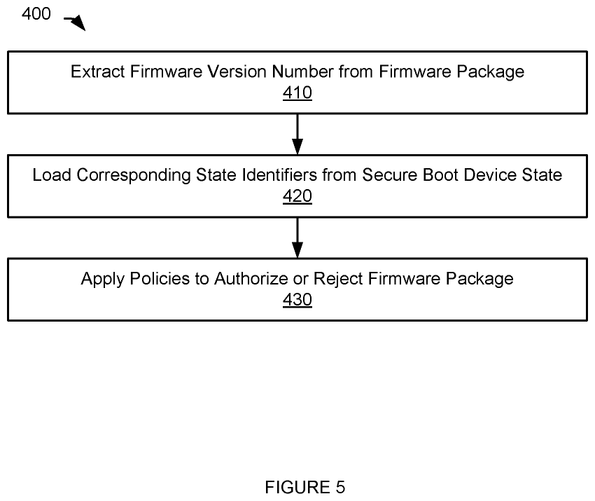

For example, and with reference to FIG. 5, a method 400 of applying a policy limiting a firmware rollback to firmware elements 202, 204 including firmware security revisions that are within a predetermined number of versions (or revisions) of the highest firmware version identifier in according to one aspect of the present embodiments. At step 410, the security revision number for each firmware element 202, 204 contained in a firmware package 200 is extracted. For example, if a firmware package 200A includes a first version (0001) of the device firmware element 202A, the policy engine 120 extracts a value of 0001 from the firmware package 200.

At step 420, the policy engine 110 loads the highest device version identifier 160C from the secure boot device state 124A. For example, in some embodiments, the highest device version identifier 160C may have a value of 0003, indicating that version 0003 of the device firmware element 202 has been present on the system 110 at some point in the past. At step 430, the policy engine 120 determines whether the firmware package 200 violates a device firmware policy. For example, the policy engine 120 can include a device firmware policy allowing rollback of the device firmware element 202 to a version having a secure revision number greater than or equal to the value of the highest device version identifier minus one. To continue the above example, the firmware package includes version 0001 of the device firmware element 202 and the highest device version identifier is 0003. Applying the policy, the highest rollback version of the device firmware element 202 is version 0002 (0003-1). Because the firmware package 200A includes a version of the device firmware element 202 having a lower security revision number (e.g., 0001<0002), the firmware package 200A is not an authorized rollback and is discarded. Although specific examples are provided herein, it will be appreciated that these examples are provided only for illustrative purposes and are not limiting. The policy engine 120 can include any suitable firmware rollback policies allowing or preventing firmware rollback according to any predetermined parameters.

With reference again to FIG. 4, in some embodiments, the policy engine 120 can include a policy value configured to authorize all firmware rollbacks, regardless of the version of the firmware elements 202, 204 included in the firmware package 200. For example, the policy engine 120 can include a global rollback authorization value. If the global rollback authorization value has a first value (such as a TRUE value), the policy unit 120 authorizes all rollbacks and the method 300 proceeds to step 370. If the global rollback authorization value has a second value (such as a FALSE value), additional authorization, such as meeting additional firmware policies, may be required to authorize the rollback and/or the rollback is not authorized.

If the firmware package 200 satisfies each of the rollback policies, the policy engine 120 approves the firmware package 200 and the method 300 proceeds to step 370. If the firmware package 200 violates any one of the rollback policies, the method 300 proceeds to step 390.

At step 370, the firmware 114 maintained on the storage media 112 is replaced with the firmware elements 202-204 included in the firmware package 200. For example, in some embodiments, the system 110 may replace the existing firmware 114 with the downloaded firmware package 200. In other embodiments, the system 110 may only replace elements 202-204 of the firmware 114 that are different than the corresponding firmware elements 202-204 in the downloaded firmware package 200. After updating the firmware 114, at step 380, the system 110 updates one or more state indicators 160A-160E in the secure boot device state 124 based on the changes made to the firmware 114. For example, in various embodiments, the secure boot device state 124 may update one or more of a secure database identifier 160A, a current device firmware version identifier 160B, a highest device firmware version identifier 160C, a current component firmware version identifier 160D, a highest component firmware version identifier 160E, and/or any other suitable identifier based on changes to the firmware 114.

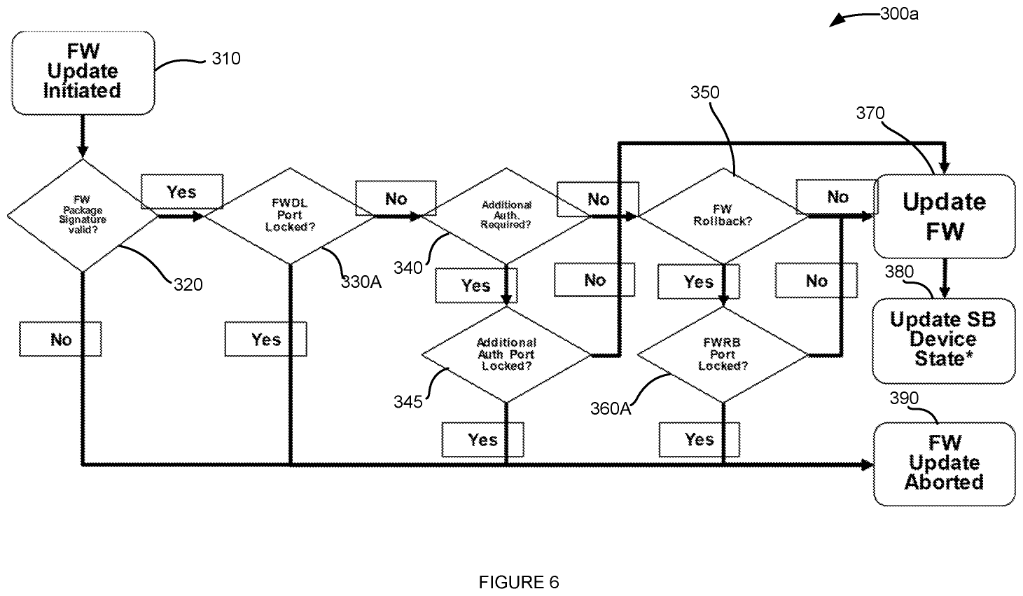

Referring now to FIG. 6, a method 300A of downloading, verifying, and authorizing a firmware update according to one aspect of the present embodiments is disclosed. The method 300A is similar to the method 300 discussed above in conjunction with FIG. 4, and similar description is not repeated herein. In method 300A, one or more ports are maintained by the system 110 and are configured to indicate an authorization status for one or more steps in the method 300A. In some embodiments, the system 110 may include one or more hardware and/or software ports associated with one or more authorization steps, such as, for example, a firmware update port, an additional authorization port, a firmware rollback port, and/or any other suitable port. For example, at step 330A, the method 300A determines whether a firmware update port is locked or unlocked. If the firmware update port is locked, the system 110 is not authorized for firmware updates and the method 300A proceeds to step 390. If the firmware update port is unlocked, firmware updates are authorized and the method 300A proceeds to step 340.

Similarly, at step 345, the system 110 determines whether any additional authorization ports are locked or unlocked. Each additional authorization required by the system 110 may have an additional authorization port associated therewith. For example, if administrative authorization is required for a firmware update, the system 110 may include an administrative port that is locked/unlocked based on the privileges currently available on the system 110 (i.e., administrative vs. non-administrative privileges). It will be appreciated that any additional authorization can include one or more ports associated therewith. If each of the required additional authorization ports are unlocked, the system 110 approves the firmware update and the method 300A proceeds to step 350. If any one of the required additional authorization ports is locked, the method 300A proceeds to step 390.

As another example, at step 360A, the system 110 determines whether a firmware rollback port is locked or unlocked. For example, in some embodiments, a firmware rollback port is configured to indicate whether general firmware rollbacks (e.g., rollback to any prior security revision number) are authorized. If the firmware rollback port is unlocked, firmware rollback is authorized and the method 300A proceeds to step 370. If the firmware rollback port is locked, firmware rollback is not authorized and the method 300A proceeds to step 390.

In some embodiments, a plurality of firmware rollback ports may be defined for each rollback policy maintained by the policy engine 120. For example, in some embodiments, the policy engine 120 may maintain a first policy allowing a device firmware element 202 to be rolled back to the highest device version identifier 160B minus one and a second policy allowing a component firmware element 204 to be rolled back to the highest component version identifier 160E minus two. The system 110 can configure a first rollback port corresponding to the first policy and a second rollback port corresponding to the second policy. Each of the first and second rollback ports may be locked and/or unlocked based on a comparison of the downloaded firmware package 200 to the current firmware 114 and/or the state identifiers 160 maintained by the secure boot device state 124. For example, to continue the above example, if a device firmware element 202 in the firmware package 200 has a security revision number greater than or equal to the value of the highest device version identifier 160C minus one, the system 110 unlocks the first rollback port. If the component firmware element 204 in the firmware package has a security revision number greater than or equal to the value of the highest component version identifier 160E minus two, the system 110 unlocks the second rollback port. It will be appreciated that a rollback port can be implemented for any number of firmware components 202-204 contained within a firmware package 200.

With reference now to FIG. 7, an exemplary standard firmware update according to one aspect of the present embodiments is disclosed. At an initial time t₀, a system 110A includes a secure database element 206, version 0002 of the device firmware element 202, version 0002 of the component firmware element 204, and a secure boot device state 124B. At time t₁, the system 110 receives a firmware package, for example, the firmware package 200C illustrated in FIG. 3C. The firmware package 200C includes version 0003 of the device firmware element 202C and version 0002 of the component firmware element 204C. After receiving the firmware package 200C, the system 110 initiates a method, such as method 300 or 300A discussed above, to verify and approve the firmware package 200C. The system 110A verifies the source of the firmware package 200C using the unique identifier 208 included in the firmware package 200C and verifies that firmware updates are authorized for the system 110A. Additionally, because the firmware package 200C includes firmware elements 202C, 204C each having a security revision number greater than or equal to the security revision number of the currently installed firmware elements 202, 204, the firmware package 200C is considered a standard firmware update and does not require rollback approval.

At time t₂, the system 110A updates the stored firmware 114 to include the firmware elements 202C, 204C included in the firmware package 200C. After updating, the system 110A includes version 0003 of the device firmware element 202. The component firmware element 204 remains unchanged, as the downloaded firmware package 200C and the firmware 114 contain the same version of the component firmware element 204, 204C. In addition to updating the device firmware element 202, the system 110A further updates the state information stored by the secure boot device state 124B. The current device firmware identifier 160B is updated to reflect the new version, version 0003, of the device firmware element 202. Additionally, because the device firmware element 202 now includes a version having the highest security revision number that has been installed on the system 110A, the highest device firmware identifier 160C is updated to reflect the new version, version 0003, of the device firmware element 202.

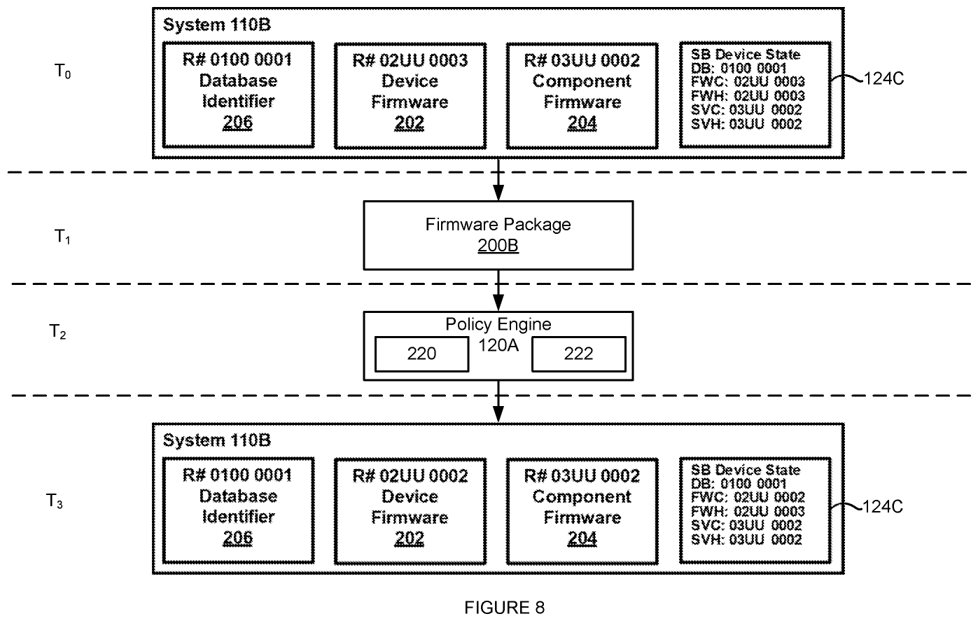

With reference now to FIG. 8, an exemplary approved firmware rollback according to one aspect of the present embodiments is disclosed. At an initial time t₀, a system 110B includes a secure database element 206, version 0003 of the device firmware element 202, version 0002 of the component firmware element 204, and a secure boot device state 124C. At time t₁, the system 110B receives a firmware package 200B as illustrated in FIG. 3B. The firmware package 200B includes version 0002 of the device firmware element 202 and version 0002 of the component firmware element 204. After receiving the firmware package 200B, the system 110 initiates a method, such as method 300 or 300A discussed above, to verify and approve the firmware package 200B. The system 110B verifies the source of the firmware package 200B using the unique identifier 208 included in the firmware package 200B and verifies that firmware updates are authorized for the system 110B. However, because the firmware package 200B includes a device firmware element 202B having a lower security revision number as compared to the device firmware element 202 currently installed on the system 110B, the firmware package 200B is identified as a rollback and requires rollback approval.

At time t₂, the firmware package 200B is provided to the policy engine 120A to perform one or more policy checks on the firmware elements 202B, 204B included in the firmware package 200B. In the illustrated embodiment, the policy engine 120A includes two policies: a first policy 220 which limits rollback of the device firmware element 202 to a version equal to or greater than the value of the highest device firmware version identifier 160C (as stored by the secure boot device state 124B) minus 1 and a second policy 222 which limits rollback of the component firmware element 204 to a version equal to or greater than the value of the highest component firmware version identifier 160E (as stored by the secure boot device state 124B) minus 1. Because each of the firmware elements 202B, 204B included in the firmware package 200B satisfy the corresponding policy 220, 222, the firmware package 200B is an approved rollback update.

At time t₃, the policy engine 120A approves the firmware package 200B and the system 110B updates the firmware 114 to include the firmware elements 202B, 204B included in the firmware package 200B. After updating, the system 110B includes version 0002 of the device firmware element 202. The component firmware element 204 remains unchanged, as the downloaded firmware package 200B and the firmware 114 contain the same version of the component firmware element 204, 204B. In addition to updating the device firmware element 202, the system 110B further updates the state information stored by the secure boot device state 124B. The current device firmware identifier 160B is updated to reflect the new version, version 0002, of the device firmware element 202. However, because the current version of the device firmware element 202 includes a lower security revision than the previously installed version, the highest device firmware identifier 160C remains unchanged and indicates that version 0003 is the highest device firmware element that has been installed on the system 110B.

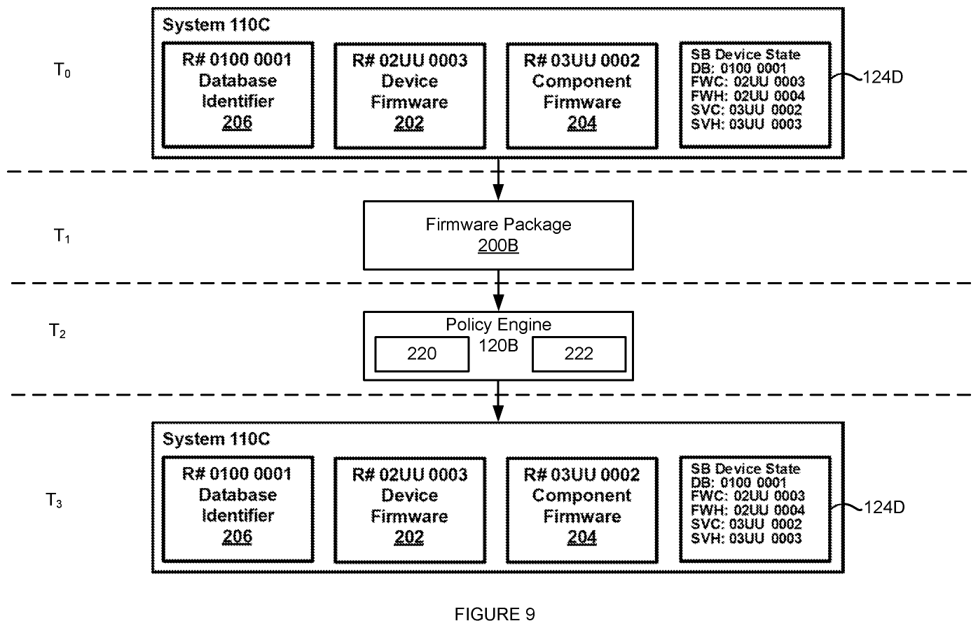

With reference now to FIG. 9, an exemplary rejected rollback update according to one aspect of the present embodiments is disclosed. At an initial time t₀, the system 110C includes a secure database element 206, version 0003 of the device firmware element 202, version 0002 of the component firmware element 204, and a secure boot device state 124D. At time t₁, the system 110C receives a firmware package 200B as illustrated in FIG. 3B. The firmware package 200B includes version 0002 of the device firmware element 202B and version 0002 of the component firmware element 204B. After receiving the firmware package 200B, the system 110C initiates a method, such as method 300 or 300A discussed above, to verify and approve the firmware package 200B. The system 110C verifies the source of the firmware package 200B using the unique identifier 208 included in the firmware package 200B and verifies that firmware updates are authorized for the system 110C. However, because the firmware package 200C includes a device firmware element 202B having a lower security revision number as compared to the device firmware element 202 currently installed on the system 110C, the firmware package 200B is identified as a rollback and requires rollback approval.

At time t₂, the firmware package 200B is provided to the policy engine 120B to perform one or more policy checks on the firmware elements 202B, 204B included in the firmware package 200B. In the illustrated embodiment, the policy engine 120B includes two policies: a first policy 220 which limits rollback of the device firmware element 202 to a version equal to or greater than the value of the highest device firmware version identifier 160C (as stored by the secure boot device state 124B) minus 1 and a second policy 222 which limits rollback of the component firmware element 204 to a version equal to or greater than the value of the highest component firmware version identifier 160E (as stored by the secure boot device state 124B) minus 1. The highest device firmware identifier 160C in the secure boot device state 124C indicates that the highest device firmware version that has been present on the system 110C was version 0004. Because the firmware package 200B includes version 0002 of the device firmware element 202B, the firmware package 200B violates the first policy 220. At time t₃, the policy engine 120B rejects the firmware package 200B. The firmware elements 202, 204 of the system 110C and the secure boot device state identifiers 160B-160E remain unchanged.

While the embodiments have been described and/or illustrated by means of particular examples, and while these embodiments and/or examples have been described in considerable detail, it is not the intention of the Applicants to restrict or in any way limit the scope of the embodiments to such detail. Additional adaptations and/or modifications or of the embodiments may readily appear, and, in its broader aspects, the embodiments may encompass these adaptations and/or modifications. Accordingly, departures may be made from the foregoing embodiments and/or examples without departing from the scope of the concepts described herein. The implementations described above and other implementations are within the scope of the following claims.

What is claimed is:

1. A method, comprising:
receiving a firmware package including at least one firmware element having a security revision number;
comparing the security revision number of the at least one firmware element to at least one firmware state identifier to determine if the firmware package is a rollback;
applying at least one rollback policy to the firmware package to approve or reject the firmware package when the firmware package is a firmware rollback; and
installing the firmware package when the firmware package is approved by the at least one rollback policy.

2. The method of claim 1, comprising verifying a digital signature of the firmware package prior to determining if the firmware package is a firmware rollback.

3. The method of claim 2, wherein the digital signature is generated using a private key and verifying the digital signature comprises comparing the digital signature to a value generated using a public key corresponding to the private key.

4. The method of claim 2, wherein the at least one firmware state identifier comprises a database identifier associated with a database of verification values.

5. The method of claim 1, comprising maintaining at least one port associated with the at least one rollback policy, wherein the at least one port is locked to indicate rejection of a firmware package based on the at least one rollback policy, and wherein the at least one port is unlocked to indicate approval of a firmware package.

6. The method of claim 1, comprising updating the at least one firmware identifier based on the at least one firmware element included in the firmware package.

7. A system, comprising:
a storage unit configured to store at least one firmware element;
a secure boot device state configured to maintain at least one state identifier associated with the at least one firmware element;
a policy engine configured to approve or reject a firmware package based on at least one rollback policy and the at least one state identifier; and
an updater configured to update the at least one firmware element stored on the storage unit when the policy engine approves the firmware package.

8. The system of claim 7, wherein the policy engine is configured to verify a digital signature of the firmware package.

9. The system of claim 8, wherein the digital signature is generated using a private key and verifying the digital signature comprises comparing the digital signature to a value generated using a public key corresponding to the private key.

10. The system of claim 7, wherein the at least one firmware state identifier includes a current security revision number and a highest security revision number.

11. The system of claim 10, wherein the at least one rollback policy includes a predetermined difference between the security revision number of the at least one firmware element and the highest security revision number.

12. The system of claim 10, wherein the at least one rollback policy includes a predetermined difference between the security revision number of the at least one firmware element and the current security revision number.

13. The system of claim 7, comprising at least one port associated with the at least one rollback policy, wherein the at least one port is locked to indicate rejection of a firmware package based on the at least one rollback policy, and wherein the at least one port is unlocked to indicate approval of a firmware package.

14. The system of claim 7, wherein the at least one firmware element is a component firmware element.

15. A method, comprising:
receiving a firmware package including a device firmware element and at least one component firmware element, each of the device firmware element and the at least one component firmware element including a security revision number;
comparing the security revision number of each of the device firmware element and the at least one firmware element to a device state identifier and at least one component state identifier to determine if the firmware package is a rollback;
applying at least one rollback policy to each of the device firmware element and the at least one component firmware element, wherein the at least one rollback policy approves or rejects the device firmware element or the at least one component firmware element based on a calculated difference between the security revision number of the device firmware element or the at least one component firmware element and a corresponding one of the device state identifier and the at least one component state identifier; and
installing the firmware package when the firmware package is approved by the at least one rollback policy.

16. The method of claim 15, wherein each of the device firmware element and the at least one component state identifier includes a current security revision number and a highest security revision number.

17. The method of claim 16, wherein the at least one rollback policy includes a predetermined difference between the security revision number of one of the device firmware element and the at least one component firmware element and the highest security revision number of a respective one of the device firmware element and the at least one component state identifier.

18. The method of claim 16, wherein the at least one rollback policy includes a predetermined difference between the security revision number of one of the device firmware element and the at least one component firmware element and the current security revision number of a respective one of the device firmware element and the at least one component state identifier.

19. The method of claim 15, wherein each of the device firmware element and the at least one component firmware element is maintained by a secure boot device state.

20. The method of claim 19, wherein the at least one rollback policy is maintained by the secure boot device state.
